(19) United States
(12) Patent Application Publication
(10) Pub. No.: US 2010/0290489 A1
(43) Pub. Date: Nov. 18, 2010

(54) ELECTRO-ABSORPTION MODULATED LASER (EML) ASSEMBLY HAVING A 1/4 WAVELENGTH PHASE SHIFT LOCATED IN THE FORWARD PORTION OF THE DISTRIBUTED FEEDBACK (DFB) OF THE EML ASSEMBLY, AND A METHOD

(75) Inventors: Michele Agresti, Turin (IT); Guido Alberto Roggero, Turin (IT); Rui Yu Fang, Turin (IT); Roberto Paoletti, Turin (IT)

Correspondence Address: Kathy Manke;Avago Technologies Limited, 4380 Ziegler Road, Fort Collins, CO, 80525, US

(73) Assignee: Avago Technologies Fiber IP (Singapore) Pte. Ltd., Singapore (SG)

(21) Appl. No.: 12/466,439

(22) Filed: May 15, 2009

(51) Int. Cl. H01S 3/10; H01S 3/08

(52) U.S. Cl. 372/26; 372/96

(57) ABSTRACT

An EML assembly is provided that has and EAM and a DFB, with the DFB having an asymmetric ¼ wavelength phase shift positioned at a location that is in front of the center of the periodic structure of the DFB. In addition, the EML assembly has a tilted or bent waveguide that reduces reflections occurring at the front end facet, thereby enabling the EAM to produce a relatively high P_{OUT} level while also achieving reduced chirp and high single-mode yield in the DFB. By providing the EML assembly with a tilted or bent waveguide, the reflections at the front end facet are reduced without having to use an AR coating on the front end facet that has an extremely low reflectivity. By avoiding the need to use an AR coating on the front end facet that has an extremely low reflectivity, the AR coating that is used on the front end facet can be made using standard sputter deposition techniques to enable higher manufacturing yields to be achieved.

### TECHNICAL FIELD OF THE INVENTION

The invention relates to electro-absorption modulated laser (EML) assemblies. More particularly, the invention relates to an EML assembly in which the distributed feedback (DFB) portion of the EML assembly has an asymmetric 1/4 wavelength shift formed therein.

### BACKGROUND OF THE INVENTION

An EML assembly is typically made up of an electro-absorption modulator (EAM) portion integrated with a single-mode DFB. An EAM is a photonic semiconductor device that allows the intensity of a laser beam to be controlled via an electric voltage. The principle of operation of the EAM is based on applying an electric field to cause a change in the absorption spectrum of this section, allowing an amplitude modulation of the light emitted by the DFB. A typical EAM has a waveguide and electrodes for applying an electric field in a direction that is perpendicular to the light propagation direction. In order to achieve a high extinction ratio, EAMs typically include a quantum well structure that provides a sharp absorption spectrum very sensitive to the applied voltage. EAMs are capable of operating at relatively low voltages and at very high speeds (e.g., gigahertz (GHz)), which makes them useful for optical fiber communications.

A typical single-mode DFB comprises a laser in which the entire laser cavity is made up of a periodic structure that functions as a distributed reflector in the wavelength range of laser action. Typically, the periodic structure (e.g., a grating structure) contains a phase shift in its center and is essentially the direct concatenation of two Bragg gratings that provide internal optical gain. An EAM can be integrated with a DFB on a single chip to form an EML that is capable of operating as a data transmitter.

EML assemblies that operate with low chirp in the 1550 nanometer (nm) range have been proposed for use in, for example, 10 to 40 kilometer (km) optical fiber links for 10 gigabit per second (Gb/s) data rate operations. One difficulty associated with the proposed EML assemblies is that frequency chirp due to back-reflection from the EAM end facet severely limits the propagation span at relatively high data rates (e.g., 10 Gb/s). Thus, minimizing the EAM end facet reflection is needed in order to increase the propagation span.

FIG. 1 illustrates a top view of a known EML assembly 2 comprising a DFB 3 and an EAM 4. One end facet 5 of the EML assembly 2 comprises a highly-reflective (HR) or anti-reflective (AR) coating. The other end facet 6 of the EML assembly 2 comprises an AR coating. An inter-contact isolation region 7 electrically isolates the DFB 3 and the EAM 4 from each other. The portions 8A and 8B of the DFB 3 and the EAM 4, respectively, together comprise a ridge 9 having a gap in it where the inter-contact isolation region 7 exists. The ridge 9 extends between the end facets 5 and 6. In layers beneath the ridge 9, an optical waveguide (not shown) exists that runs generally parallel to the ridge 9 and extends between the end facets 5 and 6. It is the occurrence of back reflection from end facet 6 into the EAM 4, and consequently, into the DFB 3, that degrades the performance of the EML assembly 2.

FIG. 2 illustrates a top view of a portion of a known EML assembly 11 comprising a DFB 13 and an EAM 17, and a grating structure 14 in the DFB 13 that has a ¼ wavelength phase shift 16 located at its center. In other words, the location of the ¼ wavelength phase shift 16 is halfway between the rear end facet 15 on the DFB 13 and the front end of the grating structure 14. A straight waveguide 19 extends through the DFB 13 and the EAM 17 between the rear and front end facets 15 and 18. The terms Lf and Lr in FIG. 2 represent the length, L, of the portion of the grating structure 14 that is in front of the location of the ¼ wavelength phase shift 16 and the length L of the portion of the grating structure 14 that is to the rear of the ¼ wavelength phase shift 16, respectively. In the terms Lf and Lr, r denotes rear, and f denotes front. In known EML assemblies, the end facet 15 on the DFB 13 is typically thought of as corresponding to the rear of the EML assembly 11 and the end facet 18 on the EAM 17 is thought of as corresponding to the front of the EML assembly 11. Therefore, end facets 15 and 18 are referred to herein as the rear and front end facets, respectively. Thus, because the location of the ¼ wavelength phase shift is in the center of the grating structure 14 in the EML assembly 11 shown in FIG. 2, Lf=Lr.

Placing the ¼ wavelength phase shift in the center of the grating structure 14 of the DFB 13 helps ensure that stable optical power is provided to the EAM 17 from the DFB 13 via the waveguide 19. This, in turn, causes the absorption state in the EAM 17 to be altered such that the output power, P_{OUT}, of the optical signal output through the front end facet 18 of the EAM 17 follows the same “on-off” pulse as the EAM voltage applied to the contact area (not shown) of the EAM 17. The optical signal that enters the EAM 17 from the DFB 13 is modulated by the EAM voltage pulse applied to the contact area of the EAM 17.

For high speed (e.g., 10 Gb/s) transmission at a wavelength of 1550 nm, there are two main issues that limit the long distance (e.g., 40-80 kilometer (km)) transmission of an EML assembly, namely, high output power (P_{OUT}) and low chirp specifications. With materials that are used in known EML assemblies that are used for such purposes, it is not easy to obtain a high P_{OUT} due to high Auger recombination in the active layers of DFB at a long operating wavelength, such as 1550 nm. Furthermore, in such EML assemblies, attempts that have been made to increase P_{OUT} have resulted in increased reflections from the front end facet (i.e., increases rather than decreases in chirp). In the EML assembly 11 shown in FIG. 2 having the ¼ wavelength phase shift in the center of DFB 13, an AR coating on the front end facet 18 is utilized to suppress end reflection. The rear end facet 16 also includes an AR coating. However, to sufficiently suppress the end reflection from the front end facet 18, an AR coating having an extremely low (usually less than 10⁻³) reflectivity is needed, which is very difficult to achieve with AR coating equipment that is currently available. Consequently, it is currently very difficult, if not impossible, to achieve a high manufacturing yield for such EML assemblies.

FIG. 3 illustrates a top view of a portion of another known EML assembly 21 in which the grating structure 24 of the DFB 23 has a ¼ wavelength phase shift 26 located to the rear of the center of the grating structure, i.e., Lf>Lr. A straight waveguide 29 extends through the DFB 23 and the EAM 25 between the rear and front end facets 22 and 27, respectively. The configuration of the DFB 23 is known as an asymmetric phase shift configuration due to the fact the ¼ wavelength phase shift location is not centered at the center of the DFB 23. This configuration is designed to achieve a reasonable trade-off between the output power, P_{OUT}, of the EML assembly 21 and the level of chirp that is present in the EML assembly 21. In essence, moving the location of the phase shift 26 rearwards of the center of the DFB 23 causes the optical power level of the optical signal being directed along the waveguide 29 from the DFB 23 into the EAM 25 to be slightly reduced compared to configurations in which the phase shift is located at the center of the DFB as shown in FIG. 2. The result is that less power is reflected from the front end facet 27, and thus the level of chirp that is present is kept relatively low. However, the reduction in the chirp level comes at the cost of a reduction in the output power level, P_{OUT}, of the EML assembly 21.

One disadvantage of the asymmetric phase-shift configuration shown in FIG. 3 is that the modification of the asymmetric phase shift creates a front/rear power ratio that results in a risk that the single-mode yield will be lost. For a centered phase-shift design of the type shown in FIG. 2, the single-mode yield is generally 100%. With an asymmetric design of the type shown in FIG. 3, the single-mode yield decreases according to the location of the phase-shift. In particular, the probability that the EML assembly will be able to achieve single-mode operations decreases as the phase-shift location is moved farther away from the DFB center.

A need exists for an EML assembly that is capable of achieving a relatively high P_{OUT} level while maintaining a relatively low chirp, that is capable of being manufactured with relatively high manufacturing yield, and that is capable of achieving high single-mode yield.

### SUMMARY OF THE INVENTION

The invention provides an EML assembly and an EML method. The EML assembly comprises a DFB, an EAM, and inter-contact isolation region between the DFB and the EAM, a rear end facet, a front end facet, and a waveguide. The DFB has a front end, a rear end and a periodic structure therebetween that acts as a distributed reflector in the wavelength range of laser action of the DFB. The periodic structure has a ¼ wavelength phase shift located therein at a location that is between the center of the DFB and the front end of the DFB. The inter-contact isolation region is adjacent the front end of the DFB and the rear end of the EAM. The rear end facet is located on the rear end of the DFB and corresponds to a rear end of the EML assembly. The front end facet is located on the front end of the EAM and corresponds to a front end of the EML assembly. The waveguide extends between the rear end facet and the front end facet and passes through the DFB and the EAM.

The method is a method for obtaining a ¼ wavelength phase shift in an EML assembly. The method comprises: providing a DFB in an EML assembly, providing an inter-contact isolation region the EML assembly, providing an EAM in the EML assembly, providing a rear end facet in the EML assembly, providing a front end facet in the EML assembly, and providing a waveguide in the EML assembly. The DFB comprises a periodic structure that acts as a distributed reflector in a wavelength range of laser action of the DFB. The periodic structure has a ¼ wavelength phase shift located therein. The DFB has a front end and a rear end. The DFB has a center location that is halfway between the front end of the DFB and the rear end of the DFB. The ¼ wavelength phase shift is located between the center location of the DFB and the front end of the DFB. The inter-contact isolation region is adjacent the front end of the DFB. The EAM has a rear end and a front end. The rear end of the EAM is adjacent the inter-contact isolation region. The rear end facet is located on the rear end of the DFB and corresponds to a rear end of the EML assembly. The front end facet is located on the front end of the EAM and corresponds to a front end of the EML assembly. The waveguide extends between the rear end facet and the front end facet and passes through the DFB and the EAM.

These and other features and advantages of the invention will become apparent from the following description, drawings and claims.

### BRIEF DESCRIPTION OF THE DRAWINGS

FIG. 1 illustrates a top view of a known EML assembly comprising a DFB and an EAM.

FIG. 2 illustrates a top view of a portion of a known EML assembly that illustrates the grating structure of the DFB having a ¼ wavelength phase shift located at its center.

FIG. 3 illustrates a top view of a portion of another known EML assembly in which the grating structure of the DFB has a ¼ wavelength phase shift located to the rear of the center of the grating structure.

FIG. 4 illustrates a top view of a portion of an EML assembly in accordance with an embodiment of the invention in which the grating structure of the DFB has a ¼ wavelength phase shift located toward the front portion of the grating structure.

FIG. 5A illustrates a top view of the final EML assembly after the electrical contact pads for the DFB and EAM shown in FIG. 4 have been added.

FIG. 5B illustrates a cross-section of the EML assembly shown in FIG. 5A taken along A-A1 line shown in FIG. 5A.

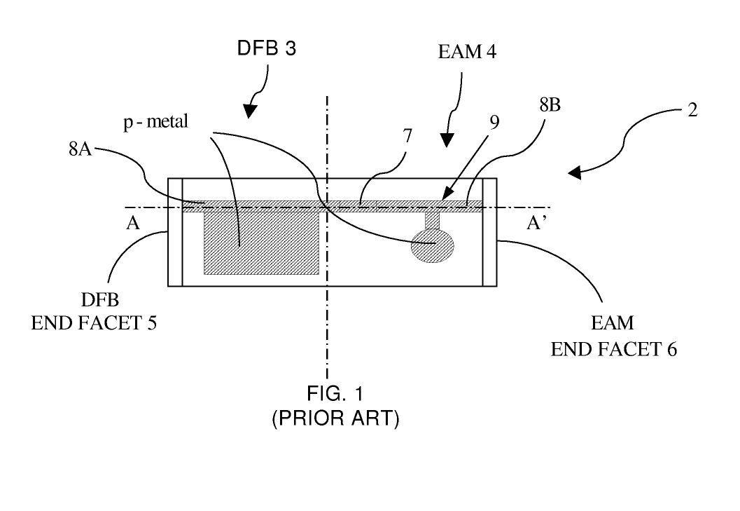

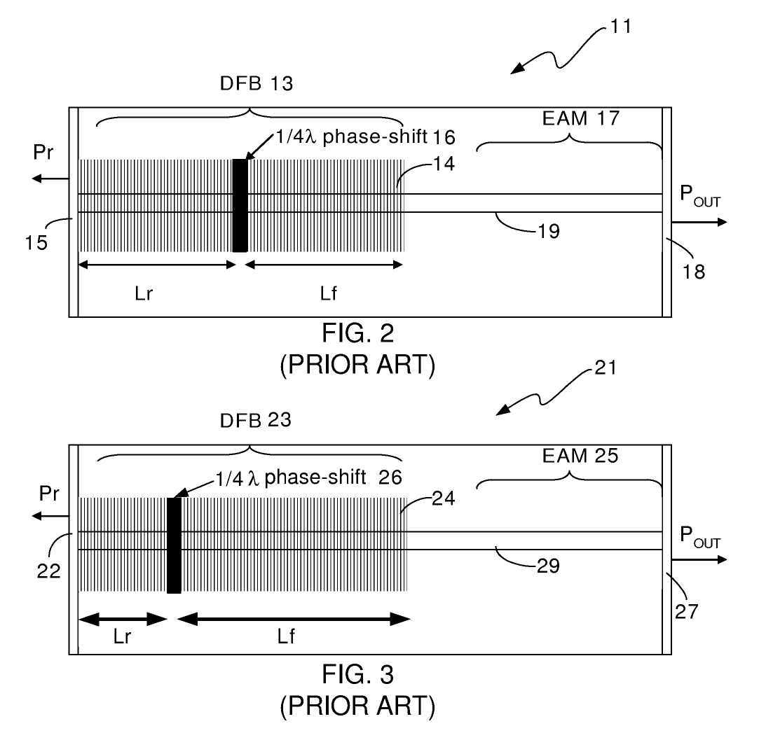

### DETAILED DESCRIPTION OF AN ILLUSTRATIVE EMBODIMENT

In accordance with the invention, an EML assembly is provided that has an EAM and a DFB, with the DFB having an asymmetric ¼ wavelength phase shift positioned at a location that is in front of the center of the diffractive grating structure of the DFB. In addition, the EML assembly has a tilted or bent waveguide that reduces reflections occurring at the front end facet, thereby enabling a relatively high output power (P_{OUT}) level from the EAM to be achieved while also achieving reduced chirp and high single-mode yield. By providing the EML assembly with a tilted or bent waveguide, the reflections at the front end facet are reduced without having to use an AR coating on the front end facet that has an extremely low reflectivity. By avoiding the need to use an AR coating on the front end facet that has an extremely low reflectivity, the AR coating that is used on the front end facet can be made using standard sputter deposition techniques to achieve higher manufacturing yields.

In accordance with an embodiment, the DFB of the EML assembly has an asymmetric ¼ wavelength phase shift that is especially designed to increase P_{OUT} at wavelengths at and around 1550 nm. The location, or position, of the phase shift is nearer to the front end facet than in known EML assemblies that have asymmetric phase shifts and is actually located between the center of the DFB and the EAM. This is in contrast to known EML assemblies of the type described above with reference to FIG. 3 in which the asymmetric phase shift is located between the center of the DFB and the rear end facet (i.e., the end facet on the DFB side of the assembly). This location of the phase shift combined with tilted or bent ridge waveguide having a typical and easily achievable AR coating on the front end facet offers many advantages, including, for example: (1) an increase in P_{OUT} by about 30%, (2) low chirp even at the higher P_{OUT} level, and (3) greater than 80% single-mode yield (i.e., side mode suppression ratio (SMSR)>30 dB) even at high injection levels.

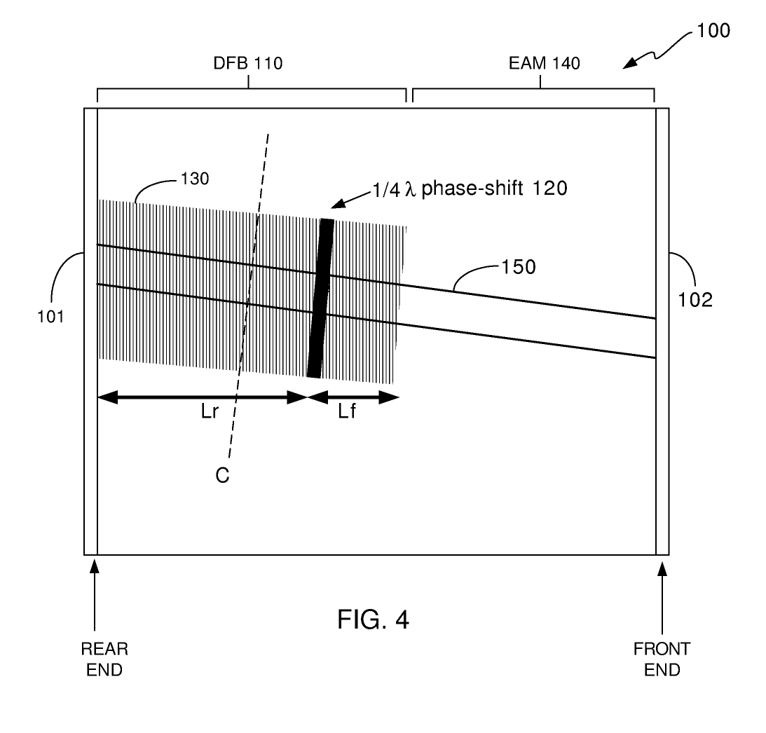

FIG. 4 illustrates a top view of a portion of an EML assembly 100 in accordance with an embodiment in which a DFB 110 of the assembly 100 has an asymmetric ¼ wavelength phase shift 120 located in front of a center, C, of a grating structure 130 of the DFB 110, and in which a tilted waveguide 150 passes through the assembly 100. The assembly 100 has a front end and a rear end, which are labeled “FRONT END” and “REAR END”, respectively, in FIG. 4. At the rear end of the assembly 100, an end facet 101 is located on the DFB 110. At the front end of the assembly 100, an end facet 102 is located on the EAM 140. In FIG. 4, the terms Lf and Lr have the same meanings as those provided above with reference to FIG. 3. Because the location of the ¼ wavelength phase shift 120 is closer to the front of the grating structure 130 than it is to the rear of the grating structure 130, Lr>Lf for the assembly 100 shown in FIG. 4.

The rear and front end facets 101 and 102, respectively, are both coated with typical AR coatings of the type that may be formed using standard sputter deposition techniques, which are capable of being performed with very high yield. The combination of the asymmetric phase shift 120 located in front of the center, C, of the DFB 110 and the tilt of the waveguide 150 provides the EML assembly 100 with a low chirp level and a high P_{OUT} level. In addition, the low chirp and high P_{OUT} levels are achieved without there being a tradeoff between them. The ratio Lr/(Lf+Lr) is selected in accordance with KL using typical DFB design techniques, where K is the coupling coefficient and L is the laser cavity length. The output power ratio of the EML assembly 100 is defined as P_{OUT}/Pr, where Pr is the optical power passing through the rear end facet 101 and P_{OUT} is the optical power passing through the front end facet 102. The output power ratio can be increased to 30% by designing the DFB 110 such that Lr/Lt=70%, where Lr has the definition given above and Lt is defined as Lr+Lf.

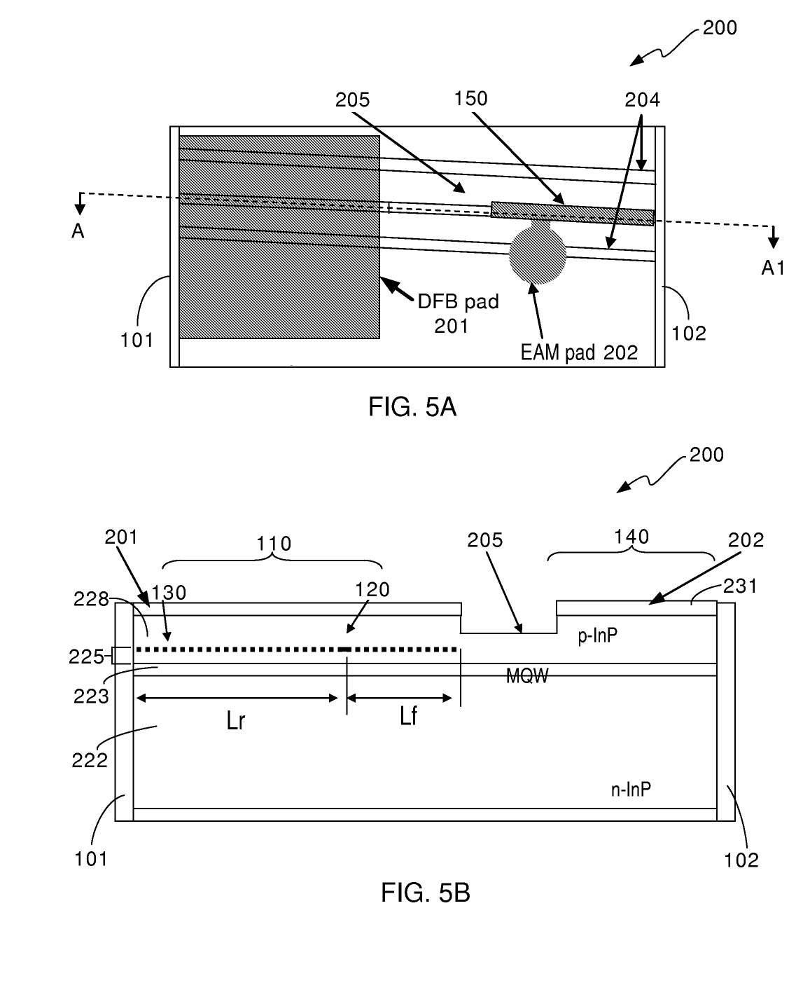

FIG. 5A illustrates a top view of the final EML assembly 200 after the electrical contact pads 201 and 202 for the DFB 110 and EAM 140, respectively, shown in FIG. 4 have been added to form the final assembly 200 shown in FIG. 5A. The waveguide 150 is a ridge waveguide that is created using a known process that includes the formation of trenches 204 on either side of the ridge waveguide 150 that run parallel to the ridge waveguide 150 from the rear end facet 101 to the front end facet 102. The process that is used to create the EML assembly 200 is described below in detail with reference to FIG. 5B. An inter-contact isolation region 205 is formed during the process to electrically isolate the DFB 110 and the EAM 140 from each other.

FIG. 5B illustrates a cross-section of the EML assembly 200 shown in FIG. 5A taken along line A-A1. As shown in FIG. 5B, the DFB 110, the grating 120 formed in the DFB 110, and the EAM 140 are made up of various layers of material. The invention is not limited with respect to the composition of materials that are used to form the EML assembly 200. For exemplary, or illustrative, purposes known processes and materials that are typically used to form an EML assembly, and which are suitable for use in creating the EML assembly 200 of the invention, will now be described. However, persons of ordinary skill in the art will understand that other processes and materials may be used to create the EML assembly of the invention.

With reference to FIG. 5B, an n-type (001) Indium Phosphide (InP) substrate (not shown) has an n-type InP buffer layer 222 formed thereon. A multi quantum well (MQW) active region comprising one or more layers 223 is grown on top of the buffer layer 222 by a process known as Selective Area Growth (SAG). One or more layers 225 that typically include at least one p-type InP spacer layer and a p-type Indium Gallium Arsenide Phosphide (InGaAsP) etch-stop layer are grown on top of the MQW active region 223. A p-type InGaAsP grating layer 228 is grown on top of one of the p-type InP spacer layers 225. The grating structure 130 having the asymmetric ¼ wavelength phase shift therein is then fabricated by using Electron Beam Lithography (EBL) and Reactive Ion Etching (RIE) of the grating layer 228 to form a periodically varying refractive index region that provides a filter for the laser spectrum in the desired wavelength range (e.g., 1550 nm). The process then continues with additional steps that are not shown for ease of illustration, such as the re-growth of a p-type InP infill and cladding layer (not shown) through use of a metallorganic chemical vapor deposition (MOCVD) growth process. A p-type InGaAs contact layer 231 is then grown on top of the cladding layer (not shown).

After the contact layer 231 is grown, a silicon oxide (SiO₂) dielectric mask (not shown) is deposited on the top of the contact layer 231 and an etching process is performed to etch the contact layer 231 and the cladding and infill layers (not shown). When the etching process is performed, the trenches 204 shown in FIG. 5A are formed to define the titled ridge waveguide 150 shown in FIG. 5A. The trenches 204 are etched deeply into the substrate 221 to eliminate any defects resulting from the SAG process. The isolation region 205 between the DFB 110 and the EAM 140 is realized through use of a combination of wet chemical etching and RIE processes. The DFB and EAM metal pads 201 and 202 are realized through use of a standard sputtering process. The end facets 101 and 102 are AR coated using a standard sputtering process.

In summary, the EML assembly has a DFB in which the ¼ wavelength phase-shift is asymmetric and is located in front of the center, C, of the DFB, as shown in FIG. 4. Locating the phase shift in this location allows the DFB to pump more optical power into the EAM. The Lr/(Lf+Lr) ratio parameters are selected in a known manner in accordance with KL. The maximum Lr/(Lf+Lr) ratio is about 70%. The output power ratio, P_{OUT}/Pr can be increased to about 30% with a Lr/(Lf+Lr) ratio of about 70%. With the foregoing design parameters, the single-mode operation yield of the EML assembly can be maintained at above about 80%. The EML assembly can be manufactured with high manufacturing yield using known EML assembly fabrication processes, such as those described above with reference to FIG. 5B, for example. The end facets are AR coated using a standard sputtering process, which facilitates the achievement of high manufacturing yields for the EML assembly. The combination of the tilted waveguide and the forward location of the ¼ wavelength phase shift eliminates the need to make tradeoffs between reductions in chirp level and increases in P_{OUT} levels.

It should be noted that the invention has been described with respect to illustrative embodiments for the purpose of describing the principles and concepts of the invention. The invention is not limited to these embodiments. For example, while the EML assembly has been described with reference to particular materials and processes that may be used to make the assembly, other materials and processes may also be used to make the assembly, as will be understood by those skilled in the art in view of the description being provided herein. Also, while the waveguide has been described as being a tilted waveguide, the waveguide may have other shapes, such as bent. A bent waveguide is generally straight through the DFB and through most of the EAM, but then bends downwards as it extends through the EAM and comes into contact with the front end facet. The manner in which a bent waveguide may be formed is also known in the art. Furthermore, while the periodic structure that acts as a distributed reflector in the wavelength range of laser action of the DFB has been described herein as a diffractive grating structure, other types of periodic structures that are not grating structures may be used for this purpose, as will be understood by persons of ordinary skill in the art in view of the description being provided herein. Many other modifications may be made to the embodiments described herein while still achieving the goals of the invention, and all such modifications are within the scope of the invention.

What is claimed is:

1. An electro-absorption modulated laser (EML) assembly comprising:
a distributed feedback laser (DFB) comprising a periodic structure that acts as a distributed reflector in a wavelength range of laser action of the DFB, the periodic structure having a ¼ wavelength phase shift located therein, the DFB having a front end and a rear end, the DFB having a center location that is halfway between the front end of the DFB and the rear end of the DFB, wherein the ¼ wavelength phase shift is located between the center location of the DFB and the front end of the DFB;
an inter-contact isolation region adjacent the front end of the DFB;
an electro-absorption modulator (EAM) having a rear end and a front end, the rear end of the EAM being adjacent the inter-contact isolation region;
a rear end facet located on the rear end of the DFB, the rear end facet corresponding to a rear end of the EML assembly;
a front end facet located on the front end of the EAM, the front end facet corresponding to a front end of the EML assembly; and
a waveguide extending between the rear end facet and the front end facet and passing through the DFB and the EAM.

2. The EML assembly of claim 1, wherein the waveguide is a tilted ridge waveguide.

3. The EML assembly of claim 1, wherein the waveguide is a bent ridge waveguide.

4. The EML assembly of claim 1, wherein the front end facet comprises an anti-reflection (AR) coating.

5. The EML assembly of claim 4, wherein the rear end facet comprises an AR coating.

6. The EML assembly of claim 1, wherein the ¼ wavelength phase shift is located a distance Lr from the rear end facet and a distance Lf from the front end of the DFB, and wherein a ratio of Lr/(Lr+Lf) is equal to or greater than 60 percent (%).

7. The EML assembly of claim 6, wherein the ratio of Lr/(Lr+Lf) is greater than 60% and equal to or less than 70%.

8. The EML assembly of claim 6, wherein the DFB has a single-mode yield that is equal to or greater than 80%.

9. The EML assembly of claim 6, wherein the ratio of Lr/(Lr+Lf) is about 70%, and wherein during operation of the EML assembly, the EML assembly has an output power ratio, P_{OUT}/Pr that is equal to about 30%, where P_{OUT} if an output power level of an optical signal output from the EAM through the front end facet and where Pr is a power level of an optical signal output through the rear end facet.

10. A method for obtaining a ¼ wavelength phase shift in an electro-absorption modulated laser (EML) assembly, the method comprising:
providing a distributed feedback laser (DFB) comprising a periodic structure that acts as a distributed reflector in a wavelength range of laser action of the DFB, the periodic structure having a ¼ wavelength phase shift located therein, the DFB having a front end and a rear end, the DFB having a center location that is halfway between the front end of the DFB and the rear end of the DFB, wherein the ¼ wavelength phase shift is located between the center location of the DFB and the front end of the DFB;
providing an inter-contact isolation region that is adjacent the front end of the DFB;
providing an electro-absorption modulator (EAM) having a rear end and a front end, the rear end of the EAM being adjacent the inter-contact isolation region;
providing a rear end facet located on the rear end of the DFB, the rear end facet corresponding to a rear end of the EML assembly;
providing a front end facet located on the front end of the EAM, the front end facet corresponding to a front end of the EML assembly; and
providing a waveguide extending between the rear end facet and the front end facet and passing through the DFB and the EAM.

11. The method of claim 10, wherein the waveguide is a tilted ridge waveguide.

12. The method of claim 10, wherein the waveguide is a bent ridge waveguide.

13. The method of claim 10, wherein the front end facet comprises an anti-reflection (AR) coating.

14. The method of claim 13, wherein the rear end facet comprises an AR coating.

15. The method of claim 10, wherein the ¼ wavelength phase shift is located a distance Lr from the rear end facet and a distance Lf from the front end of the DFB, and wherein a ratio of Lr/(Lr+Lf) is equal to or greater than 60 percent (%).

16. The method of claim 15, wherein the ratio of Lr/(Lr+Lf) is greater than 60% and equal to or less than 70%.

17. The method of claim 15, wherein the DFB has a single-mode yield that is equal to or greater than 80%.

18. The method of claim 15, wherein the ratio of Lr/(Lr+Lf) is about 70%, and wherein during operation of the EML assembly, the EML assembly has an output power ratio, P_{OUT}/Pr that is equal to about 30%, where P_{OUT} if an output power level of an optical signal output from the EAM through the front end facet and where Pr is a power level of an optical signal output through the rear end facet.
